(19) United States
(12) Patent Application Publication
(10) Pub. No.: US 2004/0252973 A1
(43) Pub. Date: Dec. 16, 2004

(54) System and method for audio/video data copy protection

(75) Inventors: Yun-sang Kim, Suwon-si (KR); Yang-lim Choi, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/849,127

(22) Filed: May 20, 2004

Related U.S. Application Data
(60) Provisional application No. 60/477,036, filed on Jun. 10, 2003.

(30) Foreign Application Priority Data
Jun. 20, 2003 (JP) 10-2003-0040404
Sep. 4, 2003 (JP) 10-2003-0061845

(51) Int. Cl. H04N 5/76

(52) U.S. Cl. 386/94; 380/201

(57) ABSTRACT

A system for preventing copying of audio/video (AV) data, including a copy control information inspection unit receiving first copy control information from AV data including an AV content information section having the first copy control information and an AV content section having second copy control information, and transmitting the first copy control information and a control command corresponding to the first copy control information, a key generation unit generating a decryption key using the first copy control information and predetermined information for the decryption key generation, according to the control command, and a decryption unit decrypting the AV data with the use of the decryption key.

This application claims priorities from Korean Patent Application Nos. 10-2003-0040404 and 10-2003-0061845, filed on Jun. 20, 2003 and Sep. 4, 2003, respectively, with the Korean Intellectual Property Office, and U.S. Provisional Patent Application No. 60/477,036 filed on Jun. 10, 2003 with the United States Patent and Trademark Office, the disclosures of which are incorporated herein in their entireties by reference.

### BACKGROUND

1. Field of Invention

The present invention relates, in general, to data copy protection, and more particularly, to a system and a method for protecting Audio/Video (hereinafter referred to as “AV”) contents from illegal copying thereof, by use of copy control information (hereinafter referred to as “CCI”) contained in an AV streaming data (hereinafter referred to as “AV data”).

2. Description of the Related Art

With the development of digital signal processing technologies, various kinds of digital recording apparatuses and media have been widely popularized. However, digital data contained in these apparatuses and media are available for repeated playing and copying. In this regard, if recording media containing illegally copied data are distributed in the market, interests to copyrighters or authorized venders, etc. of various contents of music, movies, etc. are liable to be damaged. Recently, a variety of methods to prevent illegal copying of the digital data have been introduced. Among them is a method of using copy control information.

Usually, AV data contains therein copy control information indicating a state of copy control of content in the AV stream. The copy control information indicates whether or not AV data processing systems, for example, a recorder implemented by hardware or software, has an authorization to copy the content contained in AV data received from a transmitting medium, and the recorder determines decryption of the content depending on a value of the copy control information.

The copy control information may be indicated with bits as predetermined within the AV data, usually with a 2-bit code. It is possible to establish 4 types of modes as listed in Table 1. As in Table 1, the modes capable of constituting the copy control information are as follows.

TABLE 1
Operation modes of an AV apparatus according to CCI information

| CCI code and status | | |
|---|---|---|
| of AV stream | | Description |
| 00 | ‘copy free’ | Contents are not encrypted, so copying |
| | | thereof is indefinite |
| 01 | ‘copy free | Contents are encrypted but copying thereof |
| | but encrypted’ | is indefinite |
| 10 | ‘copy one | Contents are encrypted, and only one |
| | generation’ | copying thereof is allowed. After copying, |
| | | CCI information is changed to ‘no more |
| | | copy’ |
| 11 | ‘no more copy | Contents are encrypted, and no copying |
| | or copy never’ | thereof is allowed |

FIG. 1 illustrates a schematic structure of AV data. The AV data 100 comprises a content field containing therein contents and an information field containing therein information on the contents.

The information field has a section 110 for copy control information to be used to control the copying operation of the AV apparatus, and comprises information on a variety of contents contained in the AV stream. The content field is sectioned into n sub-unit sections, that is, ‘Content_unit_{—}1,’ ‘Content_unit_{—}2,’ . . . ‘Content_unit_n.’

The section 110 for copy control information contained in the information field (hereinafter referred to as “first copy control information”) is divided into sections as many as the number of the sub-units described above. In each of the divided sections, values of copy control information such as ‘11’ and ‘10,’ etc. relative to the sub-units and location information to indicate locations of the sub-units are included. The location information may comprise physical or logical addresses relative to the sub-units, or time information when the contents in the sub-units are played. FIG. 1 refers to the location information as ‘unit_{—}1_ptr,’ ‘unit_{—}2_ptr,” . . . ‘unit_n_ptr.”

A sub-unit can be divided into one or more sections. By way of example, the sub-unit included in the content field may be divided into three small sections of ‘Sub_{—}2_{—}1,’ ‘Sub_{—}2_{—}2” and “Sub_{—}2_{—}3,” and each of the small sections may include the copy control information 130 proper thereto.

The copy control information included in each sub-unit of the content field (hereinafter referred to as “second copy control information”) is mainly used so as to generate a decryption key to decrypt the contents, and thus, if it is illegally modified, the contents cannot be decrypted. However, the first copy control information 110 is used so as to control an operation as to whether to copy the contents, and thus, illegal copying of the contents becomes possible since a third party is allowed to change the first copy control information 110.

FIG. 2 illustrates a conventional system for AV stream data copy protection to protect contents from being illegally copied.

The AV stream data copy protection system 200 to decrypt encrypted AV data comprises an AV data receive unit 210, a control unit 220, a decryption key generation unit 230, and a content interpret unit 240. The AV data receive unit 210 receives AV data. The control unit 220 receives a control signal to control an operation of an apparatus for processing AV data, inputted externally: the control signal may comprise a command signal to play an AV content, a command signal to copy the AV content, etc. At this time, the control signal may include a content playing command, a content copying command, etc. The control unit 220 receives the first copy control information 110 as depicted in FIG. 1, transmitted from the AV data receive unit 210, and transmits a control signal corresponding to a value of the first copy control information to the decryption key generation unit 230 and the content interpret unit 240.

If the description key generation unit 230 receives a command to generate the decryption key from the control unit 220, it generates a decryption key with the use of second copy control information and other information for key generation inputted from the AV data receive unit 210 and transmits the decryption key to the content interpret unit 240. The content interpret unit 240 decrypts the content field in the AV data received by the AV data receiver part with the use of the decryption key received from the decryption key generation unit 230 and transmits the decrypted content to an output device 250.

An operation of the conventional AV data processing system to decrypt the AV data is described hereinbelow.

The AV data receive unit 210 receives AV data, and transmits to the control unit 220 the first copy control information 110 included in AV data as depicted in FIG. 1.

The control unit 220 receives a control signal inputted externally to control an operation of an AV apparatus. Where the control signal is a command signal to copy the content, the control unit 220 checks an encryption status of the AV content in the AV data received by the AV data receive unit 210 by use of the first copy control information 110.

Where a value of the first copy control information 110 is ‘copy free,’ there is no need to generate a decryption key, and thus, the control unit 220 allows the content interpret unit 240 to transmit the AV data to an output device 250 as they have been received by the AV data receiver part.

If a value of the first copy control information 110 is any one of ‘no more copy or copy never,’ ‘copy free but encrypted’ and ‘copy one generation,’ data is required to be decrypted. For this purpose, the decryption key generation unit 230 receives the first copy control information 110 transmitted from the control unit 220, generates a decryption key by use of the second copy control information and other information required for generating the description key as inputted from the AV data receive unit 210, and transmits the decryption key to the content interpret unit 240. The content interpret unit 240 decrypts the content field in the AV data received by the AV data receive unit 210, by use of the decryption key as transmitted, and transmits the decrypted AV contents to an output device 250, such as a storage medium or a displaying apparatus.

The conventional AV data copy protection system 200 uses the first copy control information so as to check whether an AV apparatus has an authorization to copy the contents. However, this is problematic because the first copy control information can be easily modified for illegal copy of data. If ‘no more copy or copy never (11)’ or ‘copy one generation (10)’ is modified to ‘copy free but encrypted (01)’ or ‘no more copy or copy never (11)’ is modified to ‘copy one generation (10)’ as illustrated in Table 1 and AV data are received by the AV data receive unit 210, the control unit 220 may falsely confirm that copying of the AV data has been allowed, and therefore, illegal copying of the concerned contents can be made in an easy manner.

### SUMMARY OF THE INVENTION

The present invention is conceived to solve the aforementioned problems. An object of the present invention is to provide a method for effectively preventing decryption of contents due to illegal modification and illegal copying of the copy control information by utilizing a first copy control information where a key for encryption or decryption of data is generated.

To achieve the above and/or other objects of the present invention, there is provided a system for preventing copying of AV data, comprising a copy control information inspection unit receiving a first copy control information from AV data including an AV content information section having the first copy control information and an AV content section having second copy control information, and transmitting the first copy control information and a control command corresponding to the first copy control information, a key generation unit generating a decryption key with the use of the first copy control information and predetermined information for the decryption key generation according to the control command, and a decryption unit decrypting the AV data with the use of the decryption key.

According to another aspect of the present invention, there is provided a system for preventing copying of AV data, comprising a copy control information inspection unit receiving a first copy control information from AV data including a AV content information section having the first copy control information and an AV content section having a second copy control information, and transmitting the first copy control information and a control command corresponding to the first copy control information, a key generation unit generating an encryption key with the use of the first copy control information and predetermined information for the encryption key generation according to the control command, and an encryption unit encrypting the AV data with the use of the encryption key.

According to still another aspect of the present invention, there is provided a method for preventing copying of AV data, comprising the steps of receiving first copy control information from AV data including an AV content information section having the first copy control information and an AV content section including second copy control information, determining a control state of the first copy control information and transmitting the first copy control information and a control command corresponding to the copy control state, generating a decryption key with the use of the first copy control information and predetermined information for the decryption key generation according to the control command, and decrypting the AV data with the use of the decryption key.

According to still further another aspect of the present invention, there is provided a method for preventing copying of AV data, comprising the steps of receiving first copy control information from AV data including an AV content information section having the first copy control information and an AV content section including second copy control information, determining a control state of the first copy control information and transmitting the first copy control information and a control command corresponding to the copy control state, generating an encryption key with the use of the first copy control information and predetermined information for the encryption key generation according to the control command, and encrypting the AV data with the use of the encryption key.

Preferably, the copy control information may indicate multiple modes of copy control states by predetermined bit information, comprising a first mode in which no copy is allowed, a second mode in which contents are encrypted and one copy thereof is allowed (said second mode, is modified into the first mode after one copy), a third mode in which contents are encrypted but copying thereof is indefinitely allowed, and a fourth mode in which contents are not encrypted and copying thereof is indefinitely allowed. Also preferably, the information for encryption key generation may include the second copy control information.

### BRIEF DESCRIPTION OF THE DRAWINGS

The above and other objects and features of the present invention will become apparent from the following description of exemplary embodiments given in conjunction with the accompanying drawings, in which:

FIG. 1 is a schematic diagram illustrating a configuration of an AV stream;

FIG. 2 is a diagram illustrating a configuration of a conventional AV data processing system to prevent illegal copy of contents;

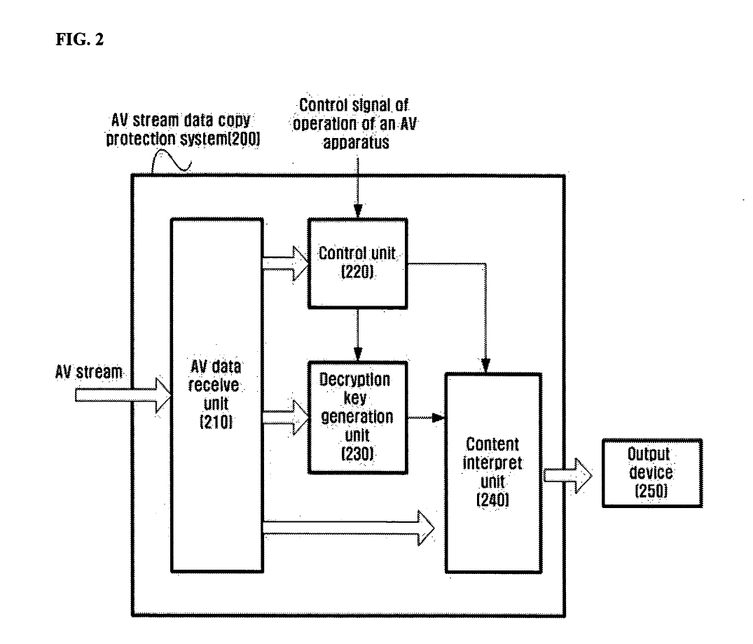

FIG. 3 is a block diagram illustrating an AV data protection system to encrypt the contents according to an exemplary embodiment of the present invention;

FIG. 4 is a diagram illustrating an AV data protection system to decrypt the contents according to an exemplary embodiment of the present invention;

FIG. 5A through 5C are diagrams illustrating media for providing AV data according to an exemplary embodiment of the present invention; and

FIG. 6 is a flow chart depicting a process for preventing illegal copying of AV data according to an embodiment of the present invention.

### DETAILED DESCRIPTION OF THE INVENTION

Hereinafter, a system and a method for AV stream data copy protection according to exemplary embodiments of the present invention will be described in detail with reference to the accompanying drawings.

A content protection system according to an embodiment of the present invention may extract contents from an AV data storage medium to play them, or decrypt encrypted contents to store them in another type of storage medium such as a hard disk and so on. Further, the content protection system may encrypt the contents so as to store them in an AV data storage medium. Accordingly, the content protection system will be described in view of two cases: to encrypt and record the contents, and to decrypt and copy the decrypted contents.

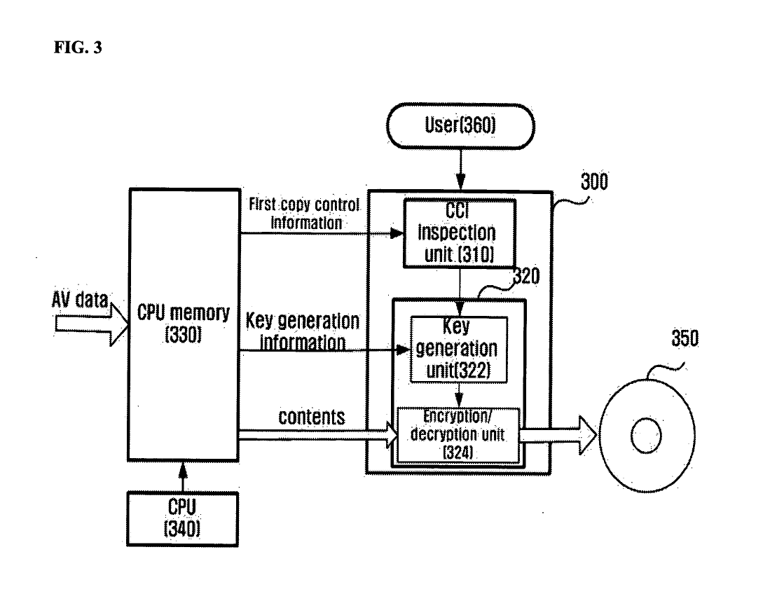

FIG. 3 is a block diagram illustrating an AV data protection system to encrypt the contents according to an embodiment of the present invention. As illustrated therein, the content protection system comprises a copy control information inspection unit 310 for inspecting a status of a first copy control information and generating a control signal in response to the inspection result, and a content processing unit 320 for generating an encryption key according to the control signal and encrypting the contents. The content protection system 300 operates linked with a CPU memory 330 receiving the AV data and a CPU 340 processing the AV data stored in the CPU memory.

Hereinbelow, a process of encrypting the contents and recording them on the AV data storage medium will be described.

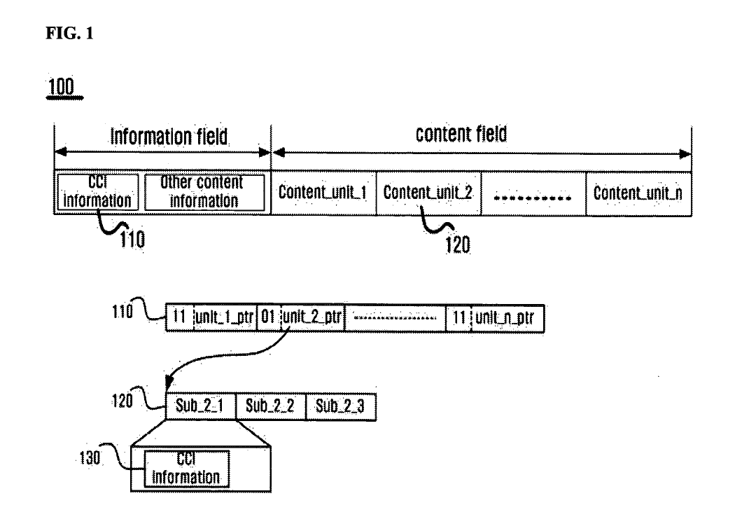

If the AV data is loaded on the CPU memory 330, the CPU 340 extracts key generation information and contents comprising first copy control information 110 and second copy control information 130 as illustrated in FIG. 1 and transmits them to the content protection system 300.

The copy control information inspection unit 310 receives a control signal relative to an operation mode of the content protection system 300 from a user 360. At this time, the operation mode comprises a mode of encrypting and recording the received AV data on the AV data storage medium 350 (‘a first mode’), a mode of decrypting the received AV data (‘a second mode’). The embodiment illustrated in FIG. 3 is operated under the first mode.

The copy control information inspection unit 310 receives the first copy control information from the CPU memory 330 and inspects a status of the copy control. The copy control status has been represented in Table 1 (shown above).

Where a copy control status of the first copy control information is ‘11,’ no copy of contents is allowed. In this regard, the copy control information inspection unit 310 controls a key generation unit 322 of a content processing unit 320 not to be operated, thereby allowing the received AV contents not to be recorded on the AV data storage medium 350.

Where a copy control status of the first copy control information is ‘00,’ the contents are not encrypted and copying thereof is free, and thus, there is no need to generate a key to encrypt the AV data. Therefore, the copy control information inspection unit 310 allows the content processing unit 320 to record the received contents on the AV data storage medium 350 without encrypting them. At this time, the first copy control information and the key generation information are together recorded.

Where a copy control status of the first copy control information is ‘0’ or ‘10,’ a key to encrypt the received contents is to be generated. The key generation unit 322 generates the key for encryption of the contents by use of the key generation information received from the CPU memory 330 and the first copy control information received from the copy control information inspection unit 310. At this time, the key generation information includes second copy control information. In addition to the second copy control information, the key generation information includes information on a device comprising the content protection system 300, a value of a common key or a secret key existing in the device, a common key or a secret key according to the AV data storage medium 350, and a seed value generated randomly for key generation.

If the key to encrypt the contents is generated by the key generation unit 322, encryption/decryption unit 324 encrypts the contents received from the CPU memory 330, by use of the key. Then, the encrypted contents are recorded on the AV data storage medium 350.

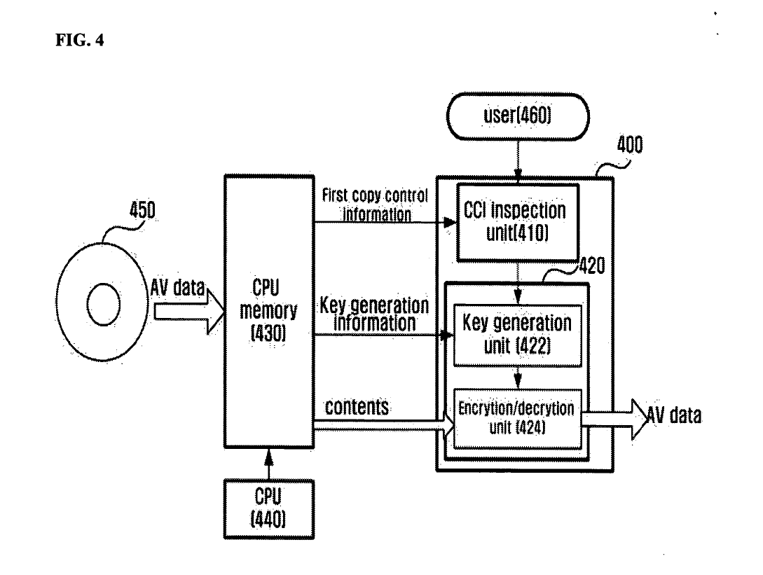

FIG. 4 is a diagram illustrating an AV data protection system to decrypt the contents according to an embodiment of the present invention.

Referring to this figure, the content protection system 400 comprises a copy control information inspection unit 410 inspecting a status of the first copy control information and generating a control signal according to the inspection result, and a content processing unit 420 generating a decryption key according to a control signal and decrypting the contents. The content protection system 400 operates linked with a CPU memory 430 receiving AV data from the AV data storage medium, and a CPU 440 processing the AV data stored in the CPU memory 430.

Hereinbelow, a process of decrypting the contents by use of the content protection system will be described.

If AV data is loaded on the CPU memory 430 from the AV data storage medium 450, the CPU extracts the first copy control information 110 shown in FIG. 1 and key generation information including second copy control information 130 from the AV data and transmits them to the content protection system 400.

The copy control information inspection unit 410 receives a control signal relative to an operation mode of the content protection system 400, from a user 460. FIG. 4 shows that it is operated under the second mode (discussed above).

The copy control information inspection unit 410 receives the first copy control information from the CPU memory 430 and inspects a status of the copy control. The copy control status is indicated on Table 1.

Where the copy control status of the first copy control information is ‘11,’ no copy of the contents is allowed. Since the copy control information inspection unit 410 allows the key generation unit 422 of the content processing unit 420 not to be operated, the received AV data is not decrypted.

Where the copy control status of the first copy control information is ‘00,’ the contents are not decrypted and copy of the contents is free, and thus, there is no need to generate a key for decryption of the AV data. Therefore, the copy control information inspector part 410 outputs the AV contents received by the content processing unit 420.

Where a copy control status of the first copy control information is ‘0’ or ‘10,’ a key to decrypt the received contents is to be generated. The key generation unit 422 generates the key for decryption of the contents by use of the key generation information received from the CPU memory 430 and the first copy control information received from the copy control information inspection unit 410. At this time, the key generation information includes second copy control information. In addition to the second copy control information, the key generation information includes information on a device comprising the content protection system 400, a value of a common key or a secret key existing in the device, a common key or a secret key according to the AV data storage medium 450, and a seed value generated randomly for key generation.

If the key for decryption of the contents is generated by the key generation unit 422, encryption/decryption unit 424 decrypts and outputs the contents received from the CPU memory 430, by use of the key.

During the above-described operational processes, if the first copy control information is illegally modified and integrated into the copy control information while the AV data is loaded on the CPU memory 330 or the first copy control information is transmitted to the copy control information inspection unit 310 from the CPU memory, a different key from the key used to encrypt the data stored in the AV data storage medium 450 may be generated. Thus, the received AV data is not decrypted.

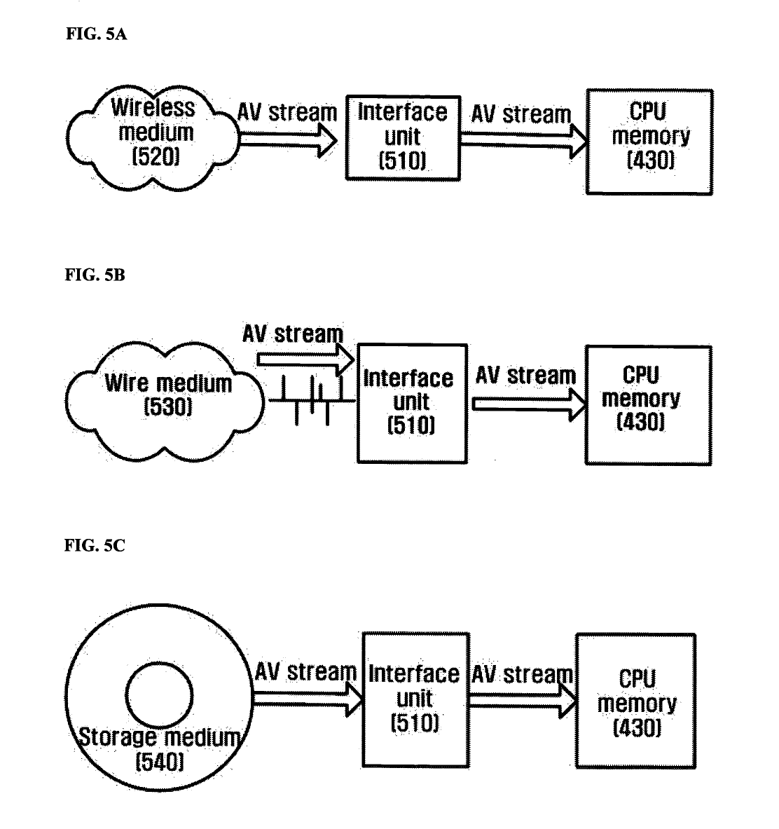

FIGS. 5A through 5C are diagrams illustrating media for providing AV data according to an embodiment of the present invention, wherein the CPU memory 430 can receive the AV data through an interface unit 510 corresponding to data transmission mediums 520, 530 and 540.

FIG. 5A represents a wireless medium for a WLAN (Wireless-LAN) based on 802.11a or 802.11b, Bluetooth, a wireless asynchronous transfer mode (ATM), Digital Terrestrial Communication or Digital Satellite Communication.

FIG. 5B represents a wired medium for Ethernet, fiberoptic digital data interface (FDDI) or high-speed serial communication such as IEEE1394.

FIG. 5C represents a storage media such as an optical storage medium, a magnetic storage medium or a mobile storage medium.

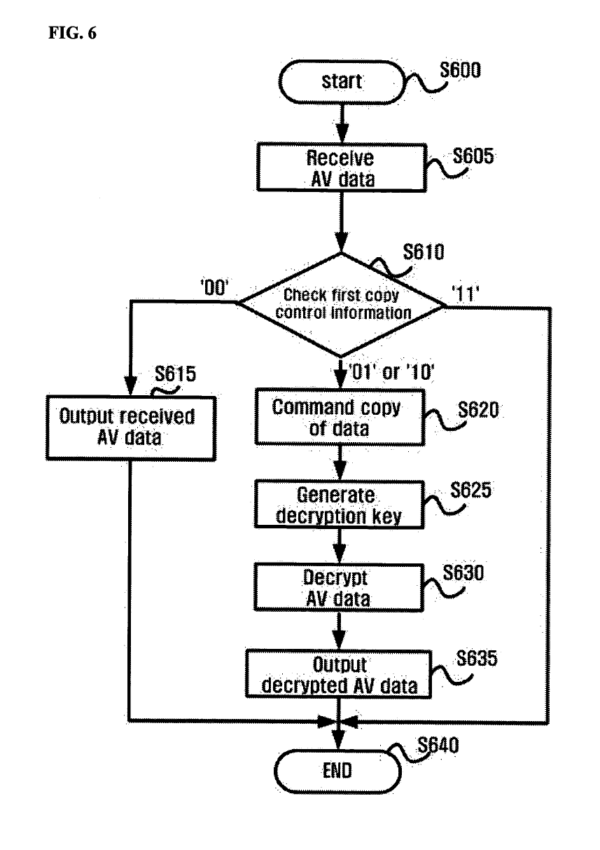

FIG. 6 is a flow chart depicting a process for preventing illegal copying of AV data according to an embodiment of the present invention.

If AV data is received S605, a first copy control information is extracted from the AV data so as to inspect a status of the copy control information S610.

If the status of the first copy control information is ‘11’ as indicated in Table 1, copying of the contents is prevented, and thus, a copying process is terminated S640.

If the status of the first copy control information is ‘00’ as indicated in Table 1, there is no need to decrypt the contents, and thus, the AV data is output as received, without passing through a decryption process S615.

Where the status of the first copy control information is ‘01’ or ‘10’ as indicated in Table 1, at least one copy will be performed. Thus, a decryption key is generated by a command to play, with the use of the first copy control information S625. At this time, the decryption key includes the second copy control information in addition to the first copy control information. The decryption key may further include a value of a common key or a secret key existing within the device, a common key or a secret key according to the medium storing therein AV data or providing the AV data, or a seed value generated randomly for the key generation.

After the decryption key is generated, the AV data received with the use of the decryption key is decrypted and then output S630 and S640.

As described above, the present invention provides a means for preventing illegal copying of AV contents due to modification of copy control information and an easy application thereof to digital electronic apparatuses for household purpose and other purposes, all of which are used in storing or copying the AV data containing copy control information, thereby contributing to content protection.

It is understood that those skilled in the art can make various substitutions, changes and modifications to the embodiments of the present invention described above without departing from the technical spirit and scope of the invention, and thus, the present invention is not limited to the embodiments illustrated in the drawings.

What is claimed is:

1. A system for preventing copying of audio/video (AV) data, comprising:
a copy control information inspection unit receiving first copy control information from the AV data including an AV content information section having the first copy control information and an AV content section having second copy control information, and transmitting the first copy control information and a control command corresponding to the first copy control information;
a key generation unit generating a decryption key using the first copy control information and predetermined information for decryption key generation according to the control command; and
a decryption unit decrypting the AV data using the decryption key.

2. The system as claimed in claim 1, wherein the copy control information indicates multiple modes of copy control statuses based on predetermined bit information, said multiple modes comprising a first mode in which no copy of AV contents is allowed, a second mode in which said AV contents are encrypted and one copy thereof is allowed, (said second mode is modified into the first mode after one copy), a third mode in which said AV contents are encrypted but copy thereof is indefinitely allowed, and a fourth mode in which said AV contents are not encrypted and copying thereof is indefinitely allowed.

3. The system as claimed in claim 1, wherein the predetermined information for the decryption key generation includes the second copy control information.

4. A system for preventing copying of audio/video (AV) data, comprising
a copy control information inspection unit receiving first copy control information from the AV data including an AV content information section having the first copy control information and an AV content section having second copy control information, and transmitting the first copy control information and a control command corresponding to the first copy control information;
a key generation unit generating an encryption key using the first copy control information and predetermined information for encryption key generation according to the control command; and
an encryption unit encrypting the AV data using the encryption key.

5. The system as claimed in claim 4, wherein the copy control information indicates multiple modes of copy control states based on predetermined bit information, said multiple modes comprising a first mode in which no copy of AV contents is allowed, a second mode in which said AV contents are encrypted and one copy thereof is allowed, said second mode is modified into the first mode after one copy, a third mode in which said AV contents are encrypted but copying thereof is indefinitely allowed, and a fourth mode in which contents are not encrypted and copying thereof is indefinitely allowed.

6. The system as claimed in claim 4, wherein the predetermined information for the encryption key generation includes the second copy control information.

7. A method for preventing copying of audio/video (AV) data, comprising:
receiving first copy control information from said AV data including an AV content information section having the first copy control information and an AV content section including second copy control information;
determining a control state of the first copy control information and transmitting the first copy control information and a control command corresponding to the determined copy control state;
generating a decryption key using the first copy control information and predetermined information for the decryption key generation, according to the control command; and
decrypting the AV data using the decryption key.

8. The method as claimed in claim 7, wherein the copy control information indicates multiple modes of copy control states by predetermined bit information, said multiple modes comprising a first mode in which no copy of AV contents is allowed, a second mode in which said AV contents are encrypted and one copy thereof is allowed, said second mode is modified into the first mode after one copy, a third mode in which said AV contents are encrypted but copying thereof is indefinitely allowed, and a fourth mode in which said AV contents are not encrypted and copying thereof is indefinitely allowed.

9. The method as claimed in claim 7, wherein the predetermined information for the decryption key generation includes the second copy control information.

10. A method for preventing copying of audio/video (AV) data, comprising:
receiving first copy control information from said AV data including an AV content information section having the first copy control information and an AV content section including second copy control information;
determining a control state of the first copy control information and transmitting the first copy control information and a control command corresponding to the determined copy control state;
generating an encryption key using the first copy control information and predetermined information for the encryption key generation, according to the control command; and
encrypting the AV data using encryption key.

11. The method as claimed in claim 10, wherein the copy control information indicates multiple modes of copy control states by predetermined bit information, said multiple modes comprising a first mode in which no copy of AV contents is allowed, a second mode in which said AV contents are encrypted and one copy thereof is allowed, said second mode is modified into the first mode after one copy, a third mode in which said AV contents are encrypted but copying thereof is indefinitely allowed, and a fourth mode in which said AV contents are not encrypted and copying thereof is indefinitely allowed.

12. The method as claimed in claim 10, wherein the predetermined information for encryption key generation includes the second copy control information.
